(19) United States
(12) Patent Application Publication
(10) Pub. No.: US 2023/0053999 A1
(43) Pub. Date: Feb. 23, 2023

(54) SYSTEM AND METHOD TO DETECT AFFILIATED PARTNERS OF AN ENTITY BASED ON A QUERY KEYWORD

(71) Applicant: SIDDHARTH MOHAN SAMEL, NAGPUR (IN)

(72) Inventor: SIDDHARTH MOHAN SAMEL, NAGPUR (IN)

(21) Appl. No.: 17/417,878

(22) PCT Filed: Apr. 30, 2021
(86) PCT No.: PCT/IB2021/053618

§ 371 Date: Jun. 24, 2021

(30) Foreign Application Priority Data
May 11, 2020 (IN) 202021019807

(51) Int. Cl. G06Q 10/06; G06F 16/9532

(52) U.S. Cl. CPC G06Q 10/06375; G06F 16/9532

(57) ABSTRACT

A system to detect affiliated partners of an entity based on a query keyword is disclosed. The system also includes a query input module, configured to receive one or more queries from one or more entities. The system includes a query synonym generation module, configured to generate a set of synonym keywords for each of one or more received queries by a keyword suggestion means. The system includes a database generation module, configured to retrieve corpus data corresponding to affiliated partners by employing a web crawler associated. technique and also configured to generate a database of the affiliated partners corresponding to the one or more entities from the corpus data based on the set of generated synonym keywords. The system includes a database screening, configured to detect related database from the generated database and also screen the detected database of the affiliated partners by cross-checking the database.

### CROSS-REFERENCE TO RELATED APPLICATION

This National Phase Application claims priority from a Complete patent application filed in India having Patent Application No. 202021019807, filed on May 11, 2020, and titled “SYSTEM AND METHOD TO DETECT AFFILIATED PARTNERS OF AN ENTITY BASED ON A QUERY KEYWORD”.

### FIELD OF INVENTION

Embodiments of a present disclosure relates to a system for data analysis application, and more particularly to a system to detect affiliated partners of an entity based on a query keyword and a method to operate the same.

### BACKGROUND

For successful enterprise operation, the connected affiliated partners play an important role. Such connection may be a reason for failure or success of the enterprise in question. For all round growth it is very important to connect with right partners. The best way to detect right partners is through identifying partners associated with a current competitor in the business domain.

In conventional approach, identifying partners for a particular domain is done manually. Manual approach of data collection is usually time taking. Moreover, manually collection of data may be not totally correct. An efficient approach would be to collect partner details automatically by minimum manual input.

As every company has details of associated partners on corresponding web pages, an efficient system may retrieve data of such partners. In addition to that for better detection of affiliated partners, it is vital to identify partners working in same domain with various synonym keywords. Such details easily be used for recruitment or acquisition purposes.

Hence, there is a need for an improved system to detect affiliated partners automatically of an entity using synonym keywords and a method to operate the same and therefore address the aforementioned issues.

### BRIEF DESCRIPTION

In accordance with one embodiment of the disclosure, a system to detect affiliated partners of an entity based on a query keyword is disclosed. The system includes one or more processors. The system also includes a query input module operable by the one or more processors. The query input module is configured to receive one or more queries from one or more entities via a computing device associated with a user. The system also includes a query synonym generation module operable by the one or more processors. The query synonym generation module is operatively coupled to the query input module. The query synonym generation module is configured to generate a set of synonym keywords for each of one or more received queries by a keyword suggestion means.

The system also includes a database generation module operable by the one or more processors. The database generation module is operatively coupled to the query synonym generation module. The database generation module is configured to retrieve corpus data corresponding to affiliated partners by employing a web crawler associated technique based on the synonym keywords for each of the one or more received queries. The database generation module is also configured to generate a database of the affiliated partners corresponding to the one or more entities from the corpus data.

The system also includes a database screening module operable by the one or more processors. The database screening module is operatively coupled to the database generation module. The database screening module is configured to detect related database from the generated database of the affiliated partners. The database screening module is also configured to screen the detected database of the affiliated partners by cross-checking the database of the affiliated partners with the one or more received queries corresponding to the entity.

The system also includes a notification module operable by the one or more processors. The notification module is operatively coupled to the database screening module. The notification module is configured to notify screened database of the affiliated partners via one or more communication means.

In accordance with one embodiment of the disclosure, a method for detecting affiliated partners of an entity based on a query keyword is disclosed. The method includes receiving one or more queries from one or more entities. The method also includes generating a set of synonym keywords for each of one or more received queries by a keyword suggestion means. The method also includes retrieving corpus data corresponding to affiliated partners by employing a web crawler associated technique based on the synonym keywords for each of the one or more received queries.

The method also includes generating a database of the affiliated partners corresponding to the one or more entities from the corpus data. The method also includes detecting related database from the generated database of the affiliated partners. The method also includes screening the detected database of the affiliated partners by cross-checking the database of the affiliated partners with the one or more received queries corresponding to the entity. The method also includes notifying screened database of the affiliated partners via one or more communication means.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system to detect affiliated partners of an entity based on a query keyword in accordance with an embodiment of the present disclosure;

FIG. 2 is a schematic representation of an embodiment representing the system to detect affiliated partners of the entity based on a query keyword of FIG. 1 in accordance of an embodiment of the present disclosure;

FIG. 3 is a block diagram of a computer or a server in accordance with an embodiment of the present disclosure; and

FIG. 4 is a flowchart representing the steps of a method for detecting affiliated partners of an entity based on a query keyword in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises... a” does not, without more constraints, preclude the existence of other devices, subsystems, elements, structures, components, additional devices, additional subsystems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system to detect affiliated partners of an entity based on a query keyword. The system includes one or more processors. The system also includes a query input module operable by the one or more processors. The query input module is configured to receive one or more queries from one or more entities via a computing device associated with a user. The system also includes a query synonym generation module operable by the one or more processors. The query synonym generation module is operatively coupled to the query input module. The query synonym generation module is configured to generate a set of synonym keywords for each of one or more received queries by a keyword suggestion means.

The system also includes a database generation module operable by the one or more processors. The database generation module is operatively coupled to the query synonym generation module. The database generation module is configured to retrieve corpus data corresponding to affiliated partners by employing a web crawler associated technique based on the synonym keywords for each of the one or more received queries. The database generation module is also configured to generate a database of the affiliated partners corresponding to the one or more entities from the corpus data.

The system also includes a database screening module operable by the one or more processors. The database screening module is operatively coupled to the database generation module. The database screening module is configured to detect related database from the generated database of the affiliated partners. The database screening module is also configured to screen the detected database of the affiliated partners by cross-checking the database of the affiliated partners with the one or more received queries corresponding to the entity.

The system also includes a notification module operable by the one or more processors. The notification module is operatively coupled to the database screening module. The notification module is configured to notify screened database of the affiliated partners via one or more communication means.

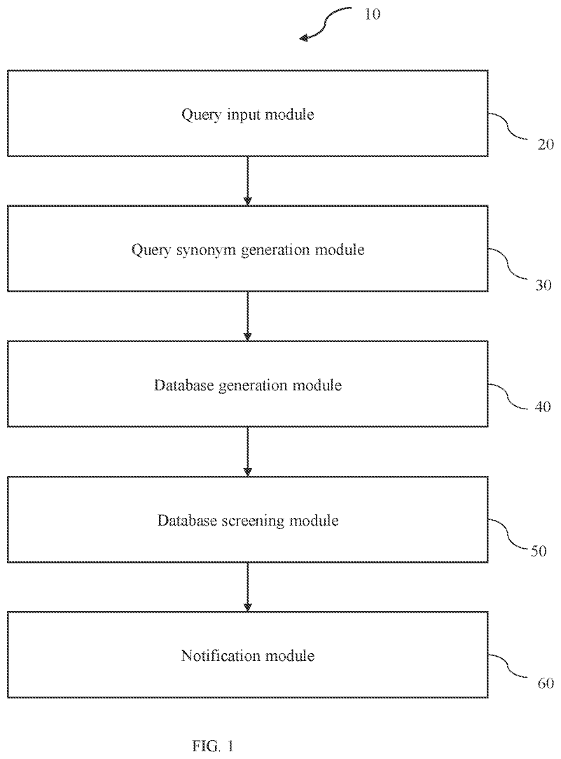

FIG. 1 is a block diagram representation of a system 10 to detect affiliated partners of an entity based on a query keyword in accordance with an embodiment of the present disclosure. In one embodiment, the system 10 enables a company or an organization to locate and partner with another organization for required domain of work. The company or the organization may be enabled to generate a database with affiliated partners details corresponding to a provided query or any nearby synonym. Further, the entity referred here is any organization or any company.

The system 10 includes one or more processors. The system 10 also includes a query input module 20 operable by the one or more processors. The query input module 20 is configured to receive one or more queries from one or more entities via one or more computing devices associated with a user. In one embodiment, the one or more queries comprises query related to campaign domain of the affiliated partners, promotion domain of the affiliated partners, content domain of the affiliated partners and advertisement domain of the affiliated partners. In such embodiment, the queries may be a single keyword of the related domain or many words query. The one or more computing devices associated with a user may include a mobile phone, smart phone, handheld device, laptop and desktop computer. The computing device is communicatively connected to the query input module 20. Wireless or wired. computing device GUI enables easy interaction of query information to the system.

The system 10 also includes a query synonym generation module 30 operable by the one or more processors. The query synonym generation module 30 is operatively coupled to the query input module 20. The query synonym generation module 30 is configured to generate a set of synonym keywords for each of one or more received queries by a keyword suggestion means. As used herein, “synonym” a word or phrase that means exactly or nearly the same as another word or phrase in the same language.

In such embodiment, the keyword suggestion means enables finding of synonyms of the query keyword as input provided by each of the one or more entity. In another embodiment, the keyword suggestion means enables discovering phrase matches for longer search terms that contain the keyword that each of the one or more entity has enquired.

The system 10 also includes a database generation module 40 operable by the one or more processors. The database generation module 40 is operatively coupled to the query synonym generation module 30. The database generation module 40 is also configured to retrieve corpus data corresponding affiliated partners by employing a web crawler associated technique based on the synonym keywords for each of the one or more received queries. The database generation module 40 is also configured to generate a database of the affiliated partners corresponding to the one or more entities from the corpus data. As used herein, the term “database” refers to a structured set of data held in a computer, especially one that is accessible in various ways. As used herein, the term “corpus” refers to a collection of linguistic data, either compiled as written texts or as a transcription of recorded speech.

In one embodiment, the database generation module 40 retrieve corpus data by utilizing a web crawler associated technique for automatic retrieving of required raw data corresponding affiliated partners. Here, the retrieved data is used for generation of database. In such embodiment, the database as generated by the database generation module comprises information such as affiliated site names, affiliated partners working domain, affiliated partners web addresses and affiliated partners contact email details if available publicly.

It is pertinent to note that, the web crawler associated technique acts with the synonym query as generated by the query synonym generation module 30. In above one exemplary embodiment, the affiliated partner associated information is retrieved out by the web crawling technique from online available data. In such exemplary embodiment, via a specific query as provided by the query input module, the system 10 web crawler technique first prioritizes a relevant content of websites. After prioritizing, the fraction of required content is retrieved. All such retrieved data is then presented on a database, thus leading to generation of database.

Furthermore, the relevant data as stated above may include website data, associated blogs, associated links and the like. In another specific embodiment, the retrieving may be filtered to certain specific domains by providing as many filtering options as possible.

The system 10 also includes a database screening module 50 operable by the one or more processors. The database screening module 50 is operatively coupled to the database generation module 40. The database screening module 50 is configured to detect related database from the generated database of the affiliated partners.

The database screening module 50 is also configured to screen the detected database of the affiliated partners by cross-checking the database of the affiliated partners with the one or more received queries corresponding to the entity. Here, checking may be manually or by machine learning technique. As used herein, “machine learning” refers to an application of artificial intelligence (AI) that provides systems the ability to automatically learn and improve from experience without being explicitly programmed.

In one specific embodiment, the retrieved electronic mail address is cross-checked by taking MX record from the email address and thereafter connecting to mail server. The connecting process makes sure the mailbox really exists for the electronic mail address.

The system 10 also includes a notification module 60 operable by the one or more processors. The notification module 60 is operatively coupled to the database screening module 50. The notification module 60 is configured to notify screened database of the affiliated partners via one or more communication means. In another embodiment, the one or more communication means refers to any handheld device or computing device. Such information is available withing a dashboard of the system 10.

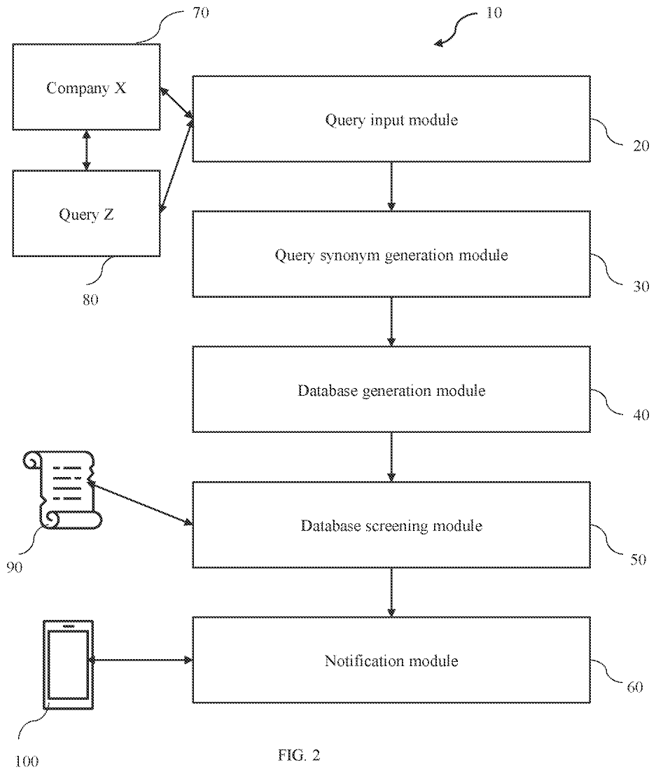

FIG. 2 is a schematic representation of an embodiment representing the system 10 to detect affiliated partners of the entity based on a query keyword of FIG. 1 in accordance of an embodiment of the present disclosure. In such exemplary embodiment, a company X 70 wants to research affiliated partners for specific marketing domain. Here, the company X 70 may provide a marketing keyword query Z 80 such as “tile seller” via the query input module 20.

A query synonym generation module 30 enables generation of one or more synonym terminologies similar to input query. Some of the generated terminologies includes “tile vendor”, “tile agent”, “slab vendor” and the like. With such generated keywords, a WebCrawler technique is used to retrieve corpus data corresponding to affiliated partners. A database generation module 40 uses such WebCrawler techniques on available online data to detect corpus data. First, the system 10 prioritizes the company X query or generated synonym query. After prioritizing, the fraction of required content is retrieved in correspondence to the query.

Further, the database generation module 40 also enables generation of a database from such detected corpus data. The database contains details such as affiliated site names, affiliated partners working domain, affiliated partners web addresses and the like.

In addition to such database generation, a database screening module 50 detects the related database and screens the database before notification via a datasheet 90. Basically, the screening is done to cross check whether provide is correct and is related to the query Z 80 corresponding to the company X 70. In such exemplary embodiment, the affiliated partners retrieved electronic mail contact detail is further cross checked by collecting the MX records from the email address and thereby connecting to mail server to make sure the retrieved affiliated partner mailbox really exist. Moreover, such screened datasheet 80 of the retrieved data are presented to company X via a handheld device 100 with help of a notification module 60.

The query input module 20, the query synonym generation module 30, the database generation module 40, the database screening module 50 and the notification module 60 in FIG. 2 is substantially equivalent to the query input module 20, the query synonym generation module 30, the database generation module 40, the database screening module 50 and the notification module 60 of FIG. 1.

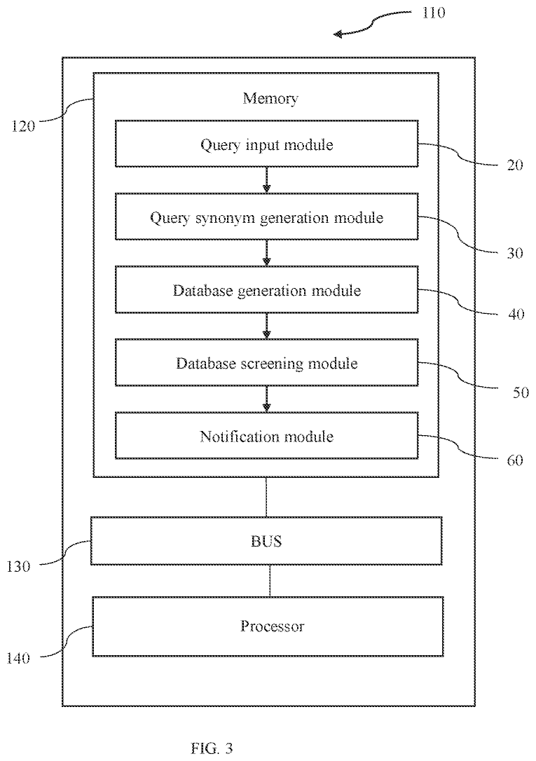

FIG. 3 is a block diagram of a computer or a server 110 in accordance with an embodiment of the present disclosure. The server 110 includes processor(s) 140, and memory 120 coupled to the processor(s) 140.

The processor(s) 140, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 120 includes a plurality of modules stored in the form of executable program which instructs the processor 140 vi a bus 130 to perform the method steps illustrated in FIG. 1. The memory 120 has following modules: the query input module 20, the query synonym generation module 30, the database generation module 40, the database screening module 50 and the notification module 60.

The query input module 20 is configured to receive one or more queries from one or more entities via a computing device associated with a user. The query synonym generation module 30 is configured to generate a set of synonym keywords for each of one or more received queries by a keyword suggestion means. The database generation module 40 is configured to retrieve corpus data corresponding to affiliated partners by employing a web crawler associated technique based on the synonym keywords for each of the one or more received queries.

The database generation module 40 is also configured to generate a database of the affiliated partners corresponding to the one or more entities from the corpus data. The database screening module 50 is configured to detect related database from the generated database of the affiliated partners. The database screening module 50 is also con figured to screen the detected database of the affiliated partners by cross-checking the database of the affiliated partners with the one or more received queries corresponding to the entity. The notification module 60 is configured to notify screened database of the affiliated partners via one or more communication means.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 140.

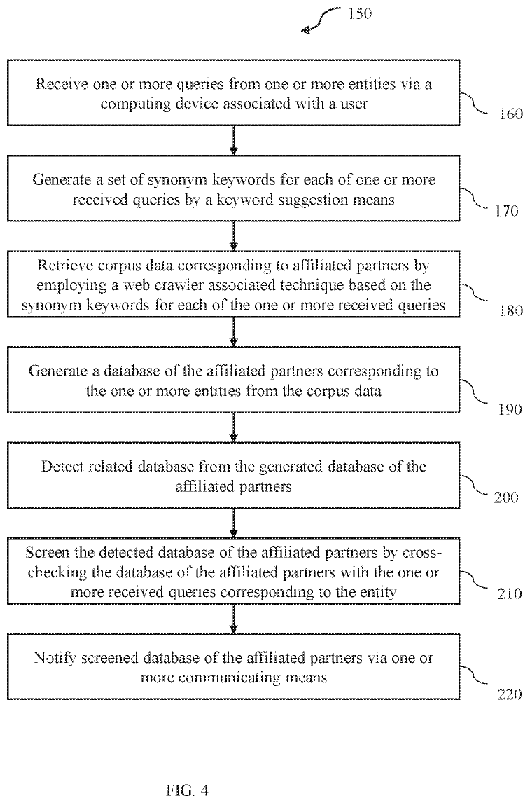

FIG. 4 is a flowchart representing the steps of a method 150 for detecting affiliated partners of an entity in accordance with an embodiment of the present disclosure. The method 150 includes receiving one or more queries from one or more entities via a computing device associated with a user in step 160. In one embodiment, receiving the one or more queries from the one or more entities includes receiving the one or more queries from the one or more entities by a query input module.

In another embodiment, receiving the one or more queries from the one or more entities includes receiving the one or more queries comprising query related to campaign domain of the affiliated partners, promotion domain of the affiliated partners, content domain of the affiliated partners and advertisement domain of the affiliated partners. In yet another embodiment, receiving the one or more queries from the one or more entities includes receiving input of query corresponding to one or more entity encompassing any organization for which affiliated partners is to be detected.

The method 150 also includes generating a set of synonym keywords for each of one or more received queries by a keyword suggestion means in step 170. In one embodiment, generating the set of synonym keywords for each of the one or more received queries by the keyword suggestion means includes generating the set of synonym keywords for each of the one or more received queries by the keyword suggestion means by a query synonym generation module.

The method 150 also includes retrieving corpus data corresponding to affiliated partners by employing a web crawler associated technique based on the synonym keywords for each of the one or more received queries in step 180. In one embodiment, retrieving the corpus data corresponding to the affiliated partners by employing the web crawler associated technique based on the synonym keywords for each of the one or more received queries includes retrieving the corpus data corresponding to the affiliated partners by employing the web crawler associated technique by a database generation module.

The method 150 also includes generating a database of the affiliated partners corresponding to the one or more entities from the corpus data in step 190. In one embodiment, generating the database of the affiliated partners corresponding to the one or more entities from the corpus data includes generating the database of the affiliated partners. corresponding to the one or more entities from the corpus data by the database generation module.

In another embodiment, generating the database of the affiliated partners corresponding to the one or more entities from the corpus data based on the set of generated synonym keywords includes generating the database of the affiliated partners comprising information such as affiliated site names, affiliated partners working domain, affiliated partners web addresses and affiliated partners contact email details if available publicly.

The method 150 also includes detecting related database from the generated database of the affiliated partners in step 200. In one embodiment, detecting the related database from the generated database of the affiliated partners includes detecting the related database from the generated database of the affiliated partners by a database screening module.

The method 150 also includes screening the detected database of the affiliated partners by cross-checking the database of the affiliated partners with the one or more received queries corresponding to the entity in step 210. In one embodiment, screening the detected database of the affiliated partners by cross-checking the database of the affiliated partners with the one or more received queries corresponding to the entity includes screening the detected database of the affiliated partners by cross-checking the database of the affiliated partners with the one or more received queries corresponding to the entity by a database screening module.

The method 150 also includes notifying screened database of the affiliated partners via one or more communication means in step 220. In one embodiment, notifying the screened database of the affiliated partners via the one or more communication means includes notifying the screened database of the affiliated partners by a notification means.

Present disclosure uses web page content details of an entity for finding affiliated partners. The system uses web crawler technology to retrieve related content from web pages. In the present disclosure, a search query is provided for a particular domain search by an entity. Here, a synonym keyword generation means is used for generating a set of synonym keywords for performing a better all-round automatic search. After search, screening of collected affiliated partner data enables double checking before usage.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. A system to detect affiliated partners of an entity, comprising:
one or more processors;
a query input module operable by the one or more processors, wherein the query input module is configured to receive one or more queries with respect to one or more entities via a computing device associated with a user;
a query synonym generation module operable by the one or more processors and operatively coupled to the query input module, wherein the query synonym generation module is configured to generate a set of synonym keywords for each of one or more received queries by a keyword suggestion means;
a database generation module operable by the one or more processors, and operatively coupled to the query synonym generation module, wherein the database generation module is configured to:
retrieve corpus data corresponding to affiliated partners by employing a web crawler associated technique based on the synonym keywords for each of the one or more received queries; and
generate a database of the affiliated partners corresponding to the one or more entities from the corpus data,
wherein the database as generated comprises information such as affiliated site names, affiliated partners working domain, affiliated partners web addresses and affiliated partners contact email details if available publicly;
a database screening module operable by the one or more processors, and operatively coupled to the database generation module, wherein the database screening module is configured to:
detect related database from the generated database of the affiliated partners; and
screen the detected database of the affiliated partners by cross-checking the database of the affiliated partners with the one or more received queries corresponding to the entity; and
a notification module operable by the one or more processors, and operatively coupled to the database screening module, wherein the notification module is configured to notify screened database of the affiliated partners via one or more communication means.

2. The system as claimed in claim 11, wherein the one or more queries comprises query related to campaign domain of the affiliated partners, promotion domain of the affiliated partners, content domain of the affiliated partners and advertisement domain of the affiliated partners.

3. The system as claimed in claim 1, wherein the one or more entity comprises any organization for which affiliated partners is to be detected.

4. A method for detecting affiliated partners of an entity, comprising:
receiving, by a query input module, one or more queries from one or more entities via a computing device associated with a user;
generating, by a query synonym generation module, a set of synonym key words for each of one or more received queries by a keyword suggestion means;
retrieving, by a database generation module, corpus data corresponding to affiliated partners by employing a web crawler associated technique based on the synonym keywords for each of the one or more received queries;
generating, by the database generation module, a database of the affiliated partners corresponding to the one or more entities from the corpus data;
detecting, by a database screening module, related database from the generated database of the affiliated partners;
screening, by the database screening module, the detected database of the affiliated partners by cross-checking the database of the affiliated partners with the one or more received queries corresponding to the entity; and
notifying, by a notification module, screened database of the affiliated partners via one or more communication means.

5. The method as claimed in claim 5, wherein generating, fiy the database generation module, the database of the affiliated partners comprises information such as affiliated site names, affiliated partners working domain, affiliated partners web addresses and affiliated partners contact email details if available publicly.

6. The method as claimed in claim 5, wherein receiving, by the query input module, the one or more queries comprises query related to campaign domain of the affiliated partners, promotion domain of the affiliated partners, content domain of the affiliated partners and advertisement domain of the affiliated partners.

7. The method as claimed in claim 5, wherein receiving, by the query input module, input of query corresponding to one or more entity encompassing any organization for which affiliated partners is to be detected.
